(19) United States
(12) Patent Application Publication
(10) Pub. No.: US 2010/0314513 A1
(43) Pub. Date: Dec. 16, 2010

(54) METHOD AND APPARATUS FOR OVERHEAD EQUIPMENT MOUNTING

(75) Inventors: ANDREW F. EVANS, RALEIGH, NC (US); MATTHEW SOPER, CLAYTON, NC (US)

Correspondence Address: THE HECKER LAW GROUP, 1925 CENTURY PARK EAST, SUITE 2300, LOS ANGELES, CA, 90067, US

(73) Assignee: RGB SYSTEMS, INC., ANAHEIM, CA (US)

(21) Appl. No.: 12/483,591

(22) Filed: Jun. 12, 2009

(51) Int. Cl. F16M 13/00; A47B 96/06

(52) U.S. Cl. 248/217.4; 248/342

(57) ABSTRACT

A method and apparatus for overhead equipment mounting is provided. In accordance with at least one embodiment, the apparatus comprises a support tube and a flange. The support tube defines a longitudinal cable access slot and a plurality of support tube perforations. The flange comprises a collar defining a plurality of first collar perforations. At least one of the plurality of first collar perforations is adapted to align with at least one of the plurality of support tube perforations. In accordance with at least one embodiment, the plurality of support tube perforations and the plurality of first collar perforations are spaced so as to allow adjustment of an equipment mounting height with fine resolution. In accordance with at least one embodiment, a cable access slot cover is adaptable to cover at least a portion of the longitudinal cable access slot.

### BACKGROUND OF THE INVENTION

(1) Field of the Invention

The present invention relates generally to a structure for mounting equipment and more particularly to a structure for mounting equipment overhead.

(2) Description of the Related Art

Audio visual presentation systems typically provide audio and/or visual presentations where they can be seen and/or heard by an audience. While some audio visual presentation systems can be supported from below, others benefit from being supported from above. For example, some audio visual presentation systems are mounted overhead, such as from a ceiling or other overhead structure.

U.S. Design Pat. 377,897 to Vogels illustrates an ornamental design for a TV ceiling support. The Vogels design patent discloses a mere design.

U.S. Pat. No. 7,156,359 to Dittmer et al. describes a secure mounting structure for overhead mounted projector. The Dittmer et al. patent is directed to a tamper-resistant overhead mounting system using at least one tamper resistant fastener to deter theft and tampering, which appears to complicate, rather than simplify, installation and/or maintenance.

Thus, an overhead equipment mount that avoids the disadvantages of the prior art is needed.

### BRIEF DESCRIPTION OF THE SEVERAL VIEWS OF THE DRAWINGS

The present invention may be better understood, and its features made apparent to those skilled in the art by referencing the accompanying drawings.

FIG. 1 is a plan view diagram of a base 101 in accordance with at least one embodiment.

FIG. 2 is a plan view diagram of a flange 201 in accordance with at least one embodiment.

FIG. 3 is a plan view diagram of a support tube 301 in accordance with at least one embodiment.

FIG. 4 is a plan view diagram of a bracket lower portion 401 in accordance with at least one embodiment.

FIG. 5 is a plan view diagram of a bracket upper portion 501 in accordance with at least one embodiment.

FIG. 6 is a perspective view diagram of an apparatus for overhead equipment mounting in accordance with at least one embodiment.

FIG. 7 is a flow diagram of a method for overhead equipment mounting in accordance with at least one embodiment.

FIG. 8 is a perspective view diagram of an bracket intermediate portion in accordance with at least one embodiment.

FIGS. 9A, 9B, and 9C are plan view diagrams of a bracket assembly in accordance with at least one embodiment.

FIG. 10 is a cross-sectional view diagram of a support tube and cable access slot cover in accordance with at least one embodiment.

The use of the same reference symbols in different drawings indicates similar or identical items.

### DETAILED DESCRIPTION OF THE INVENTION

A method and apparatus for overhead equipment mounting is provided. In accordance with at least one embodiment, the apparatus comprises a support tube and a flange. The support tube defines a longitudinal cable access slot and a plurality of support tube perforations. The flange comprises a collar defining a plurality of first collar perforations. At least one of the plurality of first collar perforations is adapted to align with at least one of the plurality of support tube perforations. In accordance with at least one embodiment, the plurality of support tube perforations and the plurality of first collar perforations are spaced so as to allow adjustment of an equipment mounting height with fine resolution. In accordance with at least one embodiment, a cable access slot cover is adaptable to cover at least a portion of the longitudinal cable access slot.

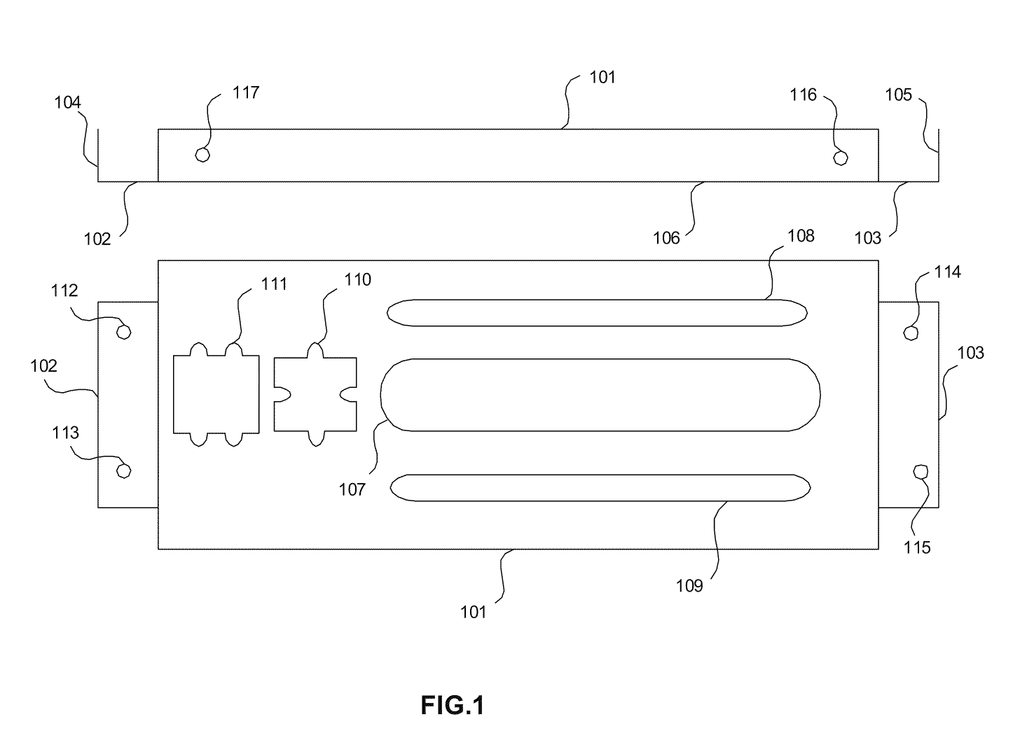

FIG. 1 is a plan view diagram of a base 101 in accordance with at least one embodiment. Base 101 may, for example, be fabricated from sheet metal. Base 101 comprises end trough 102 and end trough 103. End trough 102 comprises end plate 104. End trough 103 comprises end plate 105. End trough 102 defines perforations 112 and 113, and end trough 103 defines perforations 114 and 115. Wires may be attached to perforations 116 and 117 and to similar perforations on an opposite side of the base 101 to hang base 101 from trusses or other structural members above a drop ceiling, for example. Base 101 comprises reinforcement 106, which may be bent at an angle to the main plane of base 101 to increase the rigidity of base 101.

Several apertures may be defined in base 101 to facilitate attachment of components. For example, support tube aperture 107 and flange screw apertures 108 and 109 may be defined in base 101. A support tube may be installed through support tube aperture 107, and screws to secure a flange attached to the support tube may be installed through flange screw apertures 108 and 109. By defining support tube aperture 107 and flange screw apertures 108 and 109 in elongated forms, the position of the support tube and flange along the elongated forms of support tube aperture 107 and flange screw apertures 108 and 109 can be slidably adjustable, allowing movement of the support tube and flange closer to end trough 102, closer to end trough 103, or equidistant between end troughs 102 and 103. Apertures such as apertures 110 and 111 can be provided for mounting of accessories, such as electrical boxes, cable connectors, distribution amplifiers, signal splitters, jacks, switches, attenuators, terminations, power injectors or extractors, test instrumentation, etc.

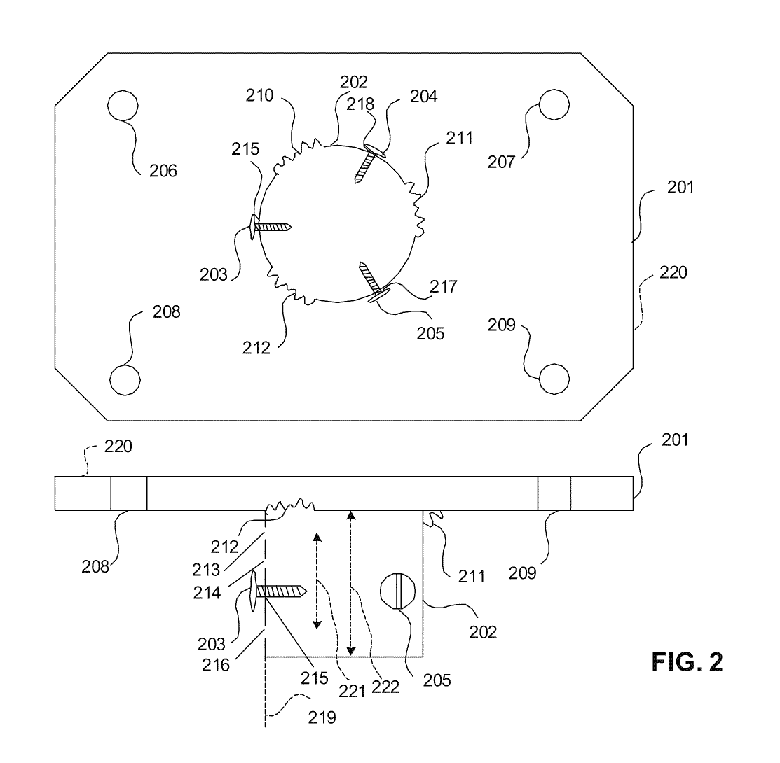

FIG. 2 is a plan view diagram of a flange 201 in accordance with at least one embodiment. Flange 201 comprises collar 202 and plate 220. Collar 202 is joined to plate 220, for example, by welds 210, 211, and 212. A plurality of plate perforations 206, 207, 208, and 209 are defined in plate 220 to allow attachment of plate 220 to base 101 using fasteners, such as screws. A plurality of first collar perforations 213, 214, 215, and 216 are defined along a collar longitudinal line 219 spanning a first portion 221 of a collar length 222 of collar 202. A fastener 203 is inserted through a collar perforation, such as collar perforation 215 to engage one of a plurality of support tube perforations in a support tube installed within collar 202. A second collar perforation 217 and a third collar perforation 218 are defined in collar 202. A second fastener 205 and a third fastener 204 are installed in second collar perforation 217 and third collar perforation 218, respectively, to engage a surface of the support tube as set screws to secure the position of the support tube with respect to collar 202.

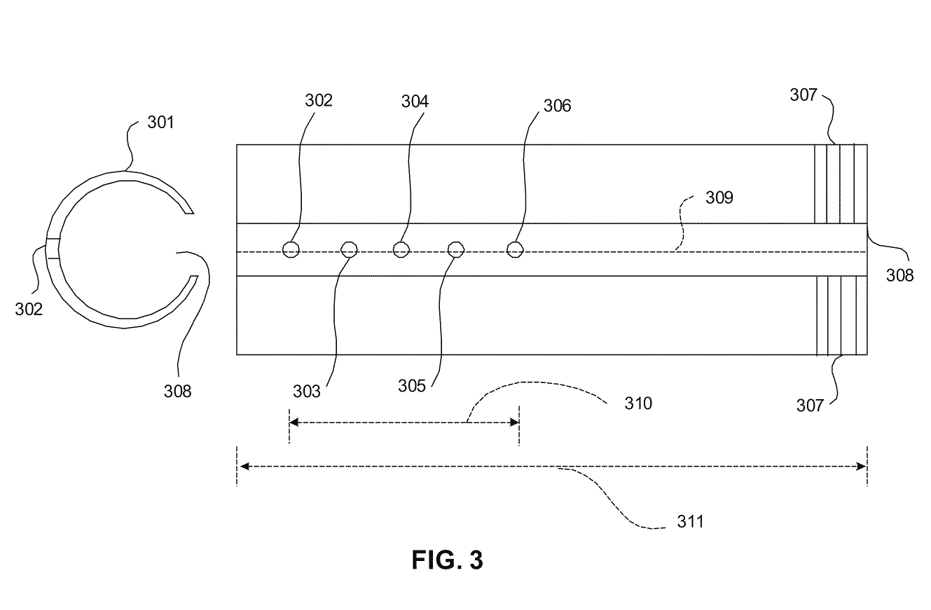

FIG. 3 is a plan view diagram of a support tube 301 in accordance with at least one embodiment. Support tube 301 defines a longitudinal cable access slot 308 and a plurality of support tube perforations 302, 303, 304, 305, and 306. In accordance with at least one embodiment, the longitudinal cable access slot 308 is diametrically opposite the plurality of support tube perforations 302, 303, 304, 305, and 306. The plurality of support tube perforations 302, 303, 304, 305, and 306 are defined along a support tube longitudinal line 309 spanning a first portion 310 of a support tube length 311 of the support tube 301. One end of support tube 301 is threaded with threads 307 to allow support tube 301 to be connected to a bracket from which equipment may be mounted. While the first portion 310 of the support tube length 311 may extend the entire length of the support tube 301, if it does not extend the entire length of the support tube 301 and is farther from one end of support tube 301 than the other end, in accordance with at least one embodiment, the end of support tube 301 from which the first portion 310 is farthest is the end which is threaded with threads 307.

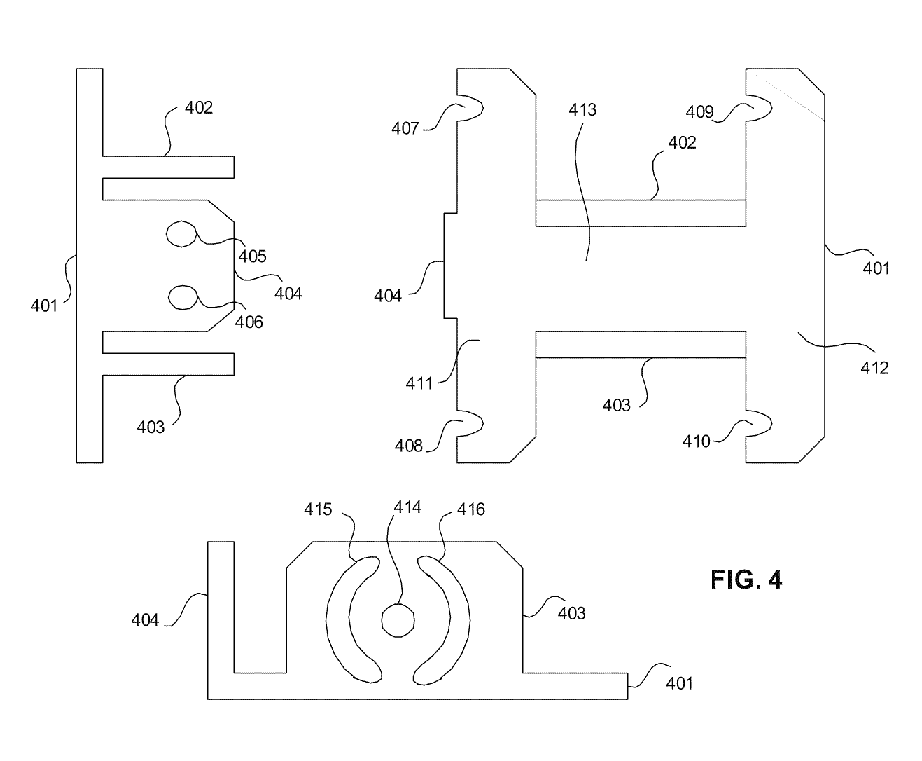

FIG. 4 is a plan view diagram of a bracket lower portion 401 in accordance with at least one embodiment. A bracket to attach equipment may comprise a bracket lower portion 401, a bracket intermediate portion, and a bracket upper portion. The bracket lower portion 401 comprises angular adjustment plates 402 and 403, mounting tab 404, front mounting plate 412, rear mounting plate 411, and central body 413. Perforations 405 and 406 are defined in mounting tab 404. Mounting notches 409 and 410 are defined in front mounting plate 412. Mounting notches 407 and 408 are defined in rear mounting plate 411. Hole 414 is defined in angular adjustment plate 403 (with a similar hole defined in angular adjustment plate 402). Arcuate angular adjustment slots 415 and 416, which surround and are concentric with hole 414, are defined in angular adjustment plate 403 (with similar arcuate adjustment slots defined in angular adjustment plate 402).

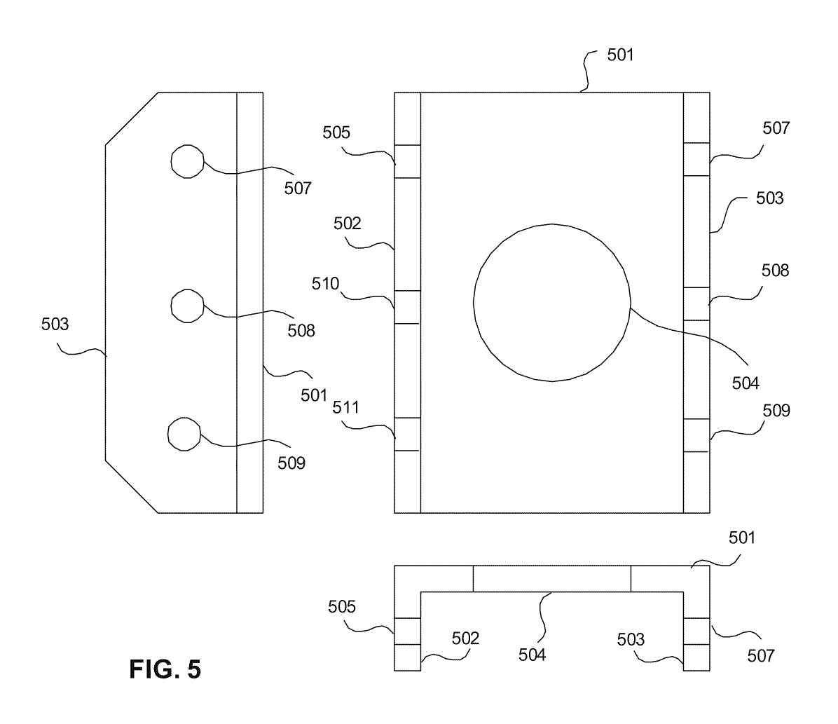

FIG. 5 is a plan view diagram of a bracket upper portion 501 in accordance with at least one embodiment. A bracket to attach equipment may comprise a bracket lower portion 401, a bracket intermediate portion, and a bracket upper portion 501. Bracket upper portion 501 comprises attachment plates 502 and 503. Bracket upper portion 501 defines support tube aperture 504, which is threaded to accept a threaded end of a support tube. Attachment plate 502 defines fastener holes 505, 510, and 511. Attachment plate 503 defines fastener holes 507, 508, and 509. Fasteners may be installed through fastener holes 507, 509, 508, 511, 505, and 510 to engage holes defined in the bracket intermediate portion. Similar fasteners may be installed through similar slots and a similar hole in angular adjustment plate 402 to pass through fastener holes defined in bracket intermediate portion 501. The fasteners passing through arcuate angular adjustment slots 415 and 416 and the corresponding opposite arcuate angular adjustment slots can be tightened when bracket lower portion 401 is adjusted at a desired angle relative to the bracket intermediate portion so as to secure bracket lower portion 401 and any equipment attached to it at the desired angle.

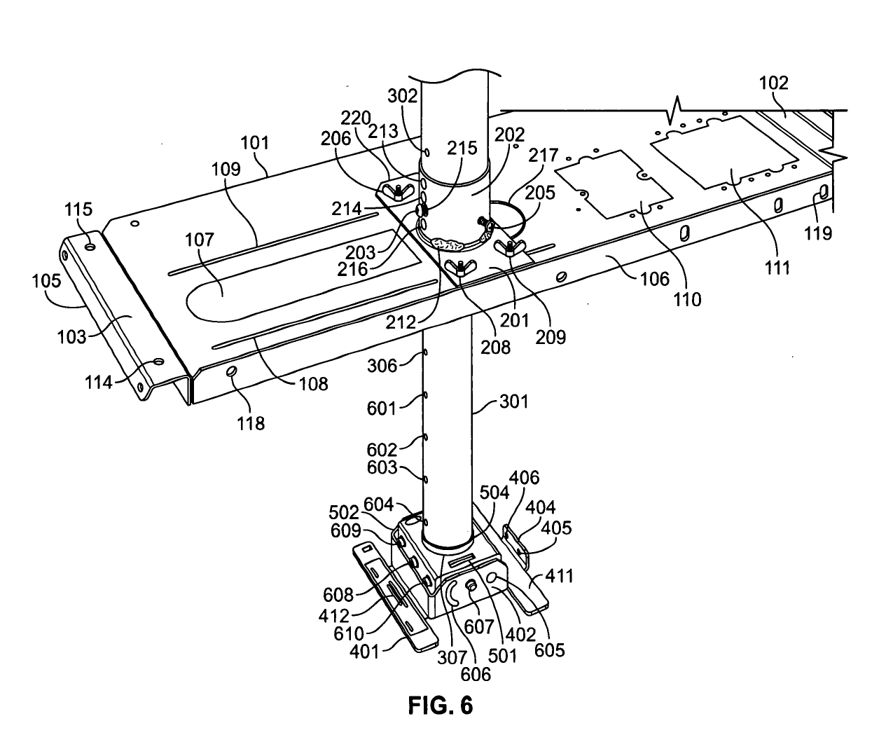

FIG. 6 is a perspective view diagram of an apparatus for overhead equipment mounting in accordance with at least one embodiment. The apparatus comprises support tube 301 and flange 201. In accordance to at least one embodiment, the apparatus further comprises base 101. In accordance to at least one embodiment, the apparatus further comprises a bracket comprising bracket upper portion 501, a bracket intermediate portion, and bracket lower portion 401.

Support tube 301 defines a plurality of support tube perforations 302, 306, 601, 602, 603, and 604, as well as support tube perforations 303, 304 and 305 visible on FIG. 3. Flange 201 comprises plate 220 and collar 202. Collar 202 defines a plurality of first collar perforations 213, 214, 215, and 216. A fastener 203 can pass through one of first collar perforations 213, 214, 215, and 216 to engage, for example, support tube perforation 303. Fasteners can be installed in the plurality of plate perforations 206, 207, 208, and 209 to secure plate 220 (and, therefore, flange 201), to base 101. Collar 202 also defines second collar perforation 217, through which second fastener 205 can be threaded and tightened to bear upon a surface of support tube 301, thereby allowing second fastener 205 to act as a set screw. Collar 202 is joined to plate 220, for example, by weld 212, so as to form flange 201.

Base 101 comprises end troughs 102 and 103 at opposite ends of base 101. End trough 103 comprises end plate 105. Perforations 114 and 115 are defined in end trough 103. Support tube aperture 107 and flange screw apertures 108 and 109 are defined in base 101. Base 101 comprises reinforcement 106, which may be made by bending base 101 at an angle, such as a right angle. Perforations 118 and 119 are defined in reinforcement 106. Wires may be installed, for example, through perforations 118 and 119 to hang base 101 from trusses or other structural members above a drop ceiling in which base 101 is installed. Other apertures, such as apertures 110 and 111 can be defined in base 101.

A lower end of support tube 301 is threaded with threads 307 to engage threads of support tube aperture 504 of bracket upper portion 501. Fasteners 608, 609, and 610 pass through fastener holes in attachment plate 502 and into a portion of a bracket intermediate portion to secure the bracket intermediate portion to bracket upper portion 501.

Fastener 605 is installed through an arcuate angular adjustment slot in angular adjustment plate 402 to pass through a fastener hole in the bracket intermediate portion. Fastener 607 is installed through a hole in angular adjustment plate 402 to pass through a fastener hole in the bracket intermediate portion. An arcuate angular adjustment slot 606, through which a fastener may be installed to pass through a fastener hole in the bracket intermediate, is also shown. Bracket lower portion 401 comprises mounting tab 404. Perforations 405 and 406 are defined in mounting tab 404. Bracket lower portion 401 also comprises rear mounting plate 411 and front mounting plate 412.

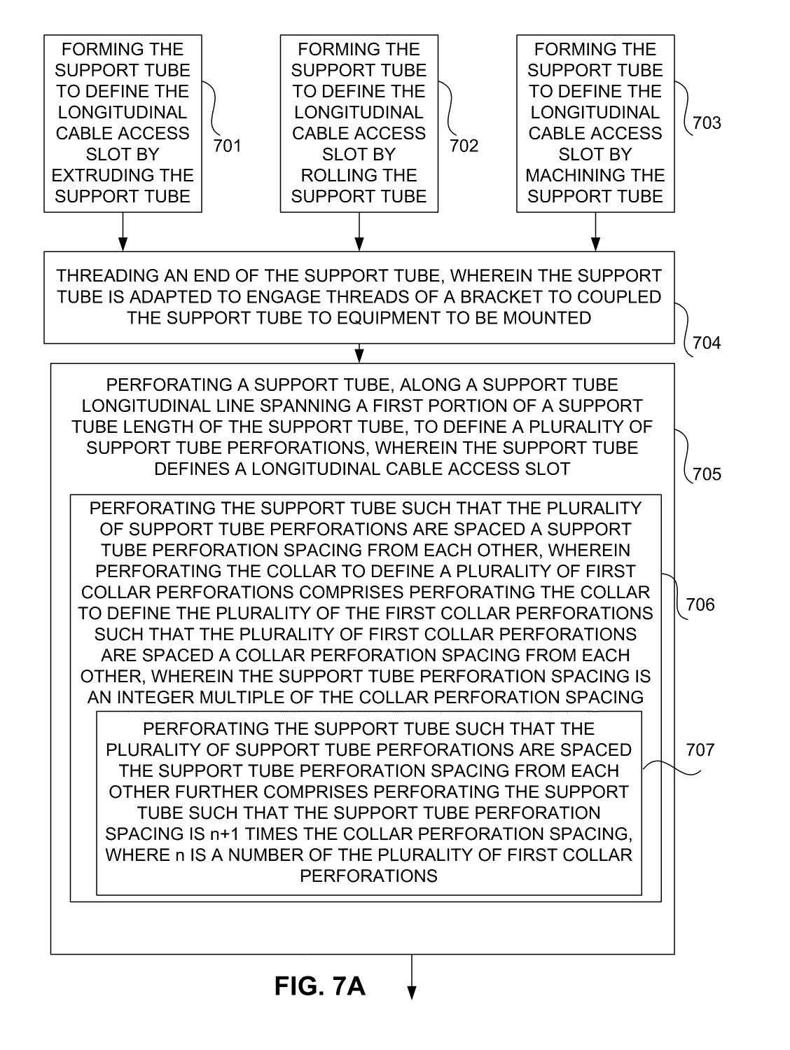

FIG. 7 is a flow diagram of a method for overhead equipment mounting in accordance with at least one embodiment. A support tube is provided. The support tube may be provided by a variety of techniques. For example, in step 701, the support tube is formed to define the longitudinal cable access slot by extruding the support tube. As another example, in step 702, the support tube is formed to define the longitudinal cable access slot by rolling the support tube into a circular cross section but leaving a gap to define the longitudinal cable access slot. As yet another example, in step 703, the support tube is formed to define the longitudinal cable access slot by machining the support tube so as to define the longitudinal cable access slot.

From any of steps 701, 702, or 703, the method continues to step 704. In step 704, an end of the support tube is threaded, wherein the support tube is adapted to engage threads of a bracket to coupled the support tube to equipment to be mounted. From step 704, the method continues to step 705. In step 705, a support tube is perforated, along a support tube longitudinal line spanning a first portion of a support tube length of the support tube, to define a plurality of support tube perforations, wherein the support tube defines a longitudinal cable access slot. In accordance with at least one embodiment, step 705 may comprise step 706. In step 706, the support tube is perforated such that the plurality of support tube perforations are spaced a support tube perforation spacing from each other, wherein perforating the collar to define a plurality of first collar perforations comprises perforating the collar to define the plurality of the first collar perforations such that the plurality of first collar perforations are spaced a collar perforation spacing from each other, wherein the support tube perforation spacing is an integer multiple of the collar perforation spacing. In accordance with at least one embodiment, step 706 may comprise step 707. In step 707, the support tube is perforated such that the plurality of support tube perforations are spaced the support tube perforation spacing from each other such that the support tube perforation spacing is n times the collar perforation spacing, where n is a number of the plurality of first collar perforations. As an example, with n equal to four, the support tube perforation spacing of the support tube perforations is four times the collar perforation spacing of the first collar perforations. In accordance with such an example, if the support tube perforations are spaced two inches apart, the collar perforations would be spaced half an inch apart, allowing for adjustment of the support tube position in half-inch increments without having to perforate the support tube every half inch.

From step 705, the method continues to step 708. In step 708, the collar is perforated to define a plurality of first collar perforations, wherein the plurality of first collar perforations are defined along a collar longitudinal line spanning a first portion of a collar length of the collar, at least one of the plurality of first collar perforations adapted to align with at least one of the plurality of support tube perforations, one of the plurality of first collar perforations further adapted to receive a fastener, one of the plurality of support tube perforations adapted for engagement of the fastener. From step 708, the method continues to step 709. In step 709, the collar is perforated to define a second collar perforation angularly offset from the collar longitudinal line and a third collar perforation angularly offset from the collar longitudinal line and from the second collar perforation, the second and third collar perforations adapted to receive, respectively, a second fastener and a third fastener, the support tube adapted to engage the second and third fasteners.

From step 709, the method continues to step 710. In step 710, threads are tapped in the plurality of support tube perforations, the second collar perforation, and the third collar perforation. From step 710, the method continues to step 711. In step 711, a plate is joined to a collar to form a flange. For example, the plate may be welded to the collar to form the flange. From step 711, the method continues to step 712. In step 712, a cable access slot cover adaptable to cover at least a portion of the longitudinal cable access slot is extruded.

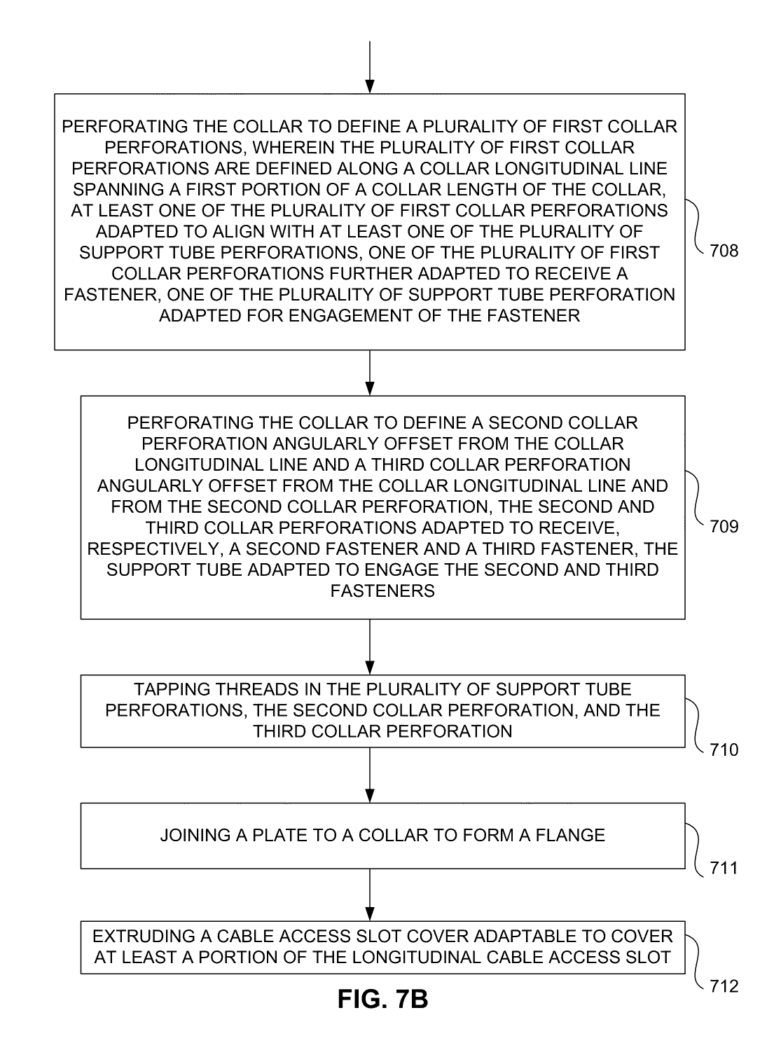

FIG. 8 is a perspective view diagram of an bracket intermediate portion 801 in accordance with at least one embodiment. The bracket intermediate portion 801 is rectangular in shape and comprises first opposing sides to couple to upper bracket portion 501 and second opposing sides to couple to lower bracket portion 401. The first opposing sides define holes 807, 808, 809, 805, 810, and 811, with a first side 822 of the first opposing sides defining holes 807, 808, and 809, and a second side 821 of the first opposition sides defining holes 805, 810, and 811. Fasteners may be installed through fastener holes 507, 509, 508, 511, 505, and 510 of upper bracket portion 501 to engage holes 807, 809, 808, 811, 805, and 810, respectively, of bracket intermediate portion 801. The second opposing sides define holes 814, 815, 816, 817, and 818. Fasteners may be installed through arcuate angular adjustment slots 415 and 416 and hole 414 to engage holes 815, 816, 814, respectively, of bracket intermediate portion 801. Fasteners may also be installed through arcuate angular adjustment slots on the opposite side of lower bracket portion 401 to engage holes 817, 818, and another hole not visible in end plate 824 of bracket intermediate portion 801. End plate 824 defines a tab 827. End plate 823, which opposes end plate 824, defines holes 814, 815, and 816 and tab 828.

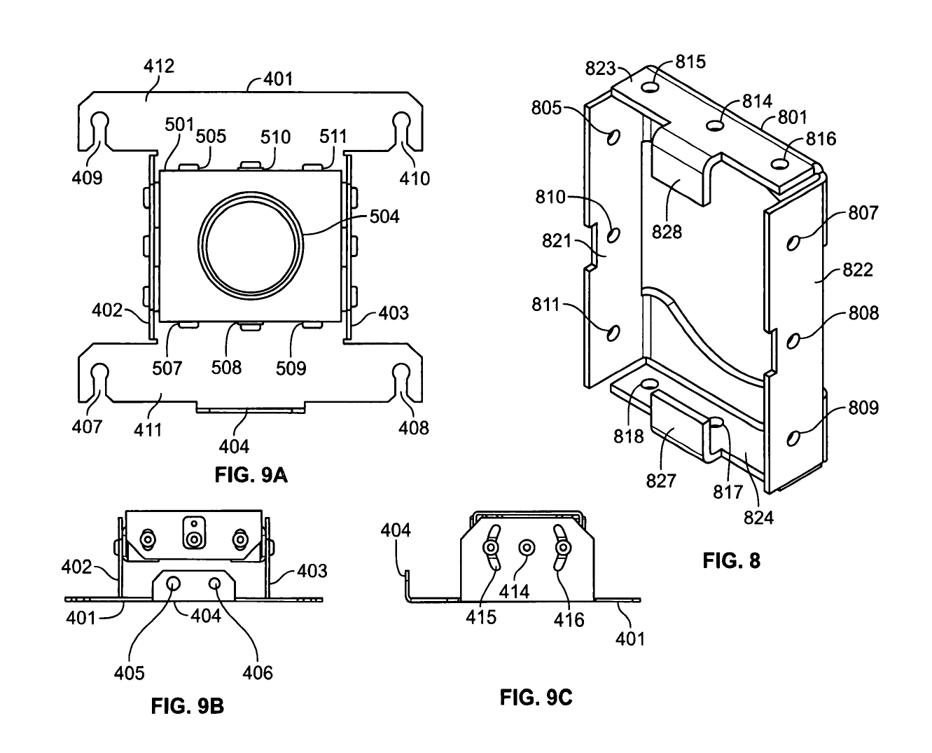

FIGS. 9A, 9B, and 9C are plan view diagrams of a bracket assembly in accordance with at least one embodiment. FIGS. 9A, 9B, and 9C depict upper bracket portion 501 attached to bracket intermediate portion 801 by fasteners 507, 508, 509, 505, 510, and 511 and bracket intermediate portion 801 attached to lower bracket portion 401 by another six fasteners. In accordance with at least one embodiment, holes defined in upper bracket portion 501, such as the holes through which fasteners 507 and 508 are installed, can be defined as arcuate angular adjustment slots, allowing upper bracket portion 501 to be adjusted relative to bracket intermediate portion 801 in a manner similar to that in which arcuate angular adjustment slots 415 and 416 of lower bracket portion 401 allow lower bracket portion 401 to be adjusted relative to bracket intermediate portion 801. Since the first opposing sides of bracket intermediate portion 801 that couple to upper bracket portion 501 are orthogonal to the second opposing sides of bracket intermediate portion 801 that couple to lower bracket portion 401, the adjustment afforded by bracket intermediate portion 801 with respect to upper bracket portion 501 is about a first axis orthogonal to a second axis about which bracket intermediate portion 801 affords adjustment relative to lower bracket portion 401. Thus, bracket intermediate portion 801 implements a form of universal joint allowing adjustment of equipment, such as a video projector, with respect to two orthogonal axes.

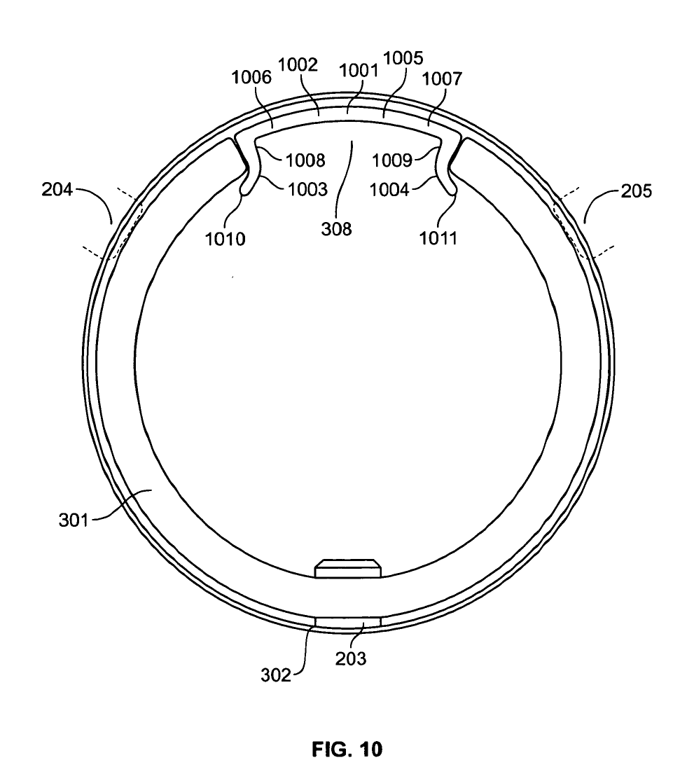

FIG. 10 is a cross-sectional view diagram of a support tube and cable access slot cover in accordance with at least one embodiment. Support tube 301 defines a longitudinal cable access slot 308 and a support tube perforation 302. The longitudinal cable access slot 308 can be filled with a cable access slot cover 1001. The plastic trim profile of the cable access slot cover 1001 is designed with a varying wall thickness such that the force is evenly distributed when pinched to install. The even distribution of force makes the cable access slot cover 1001 easy to install and/or remove and allows it to hold firmly in place without additional fasteners.

The cable access slot cover 1001 comprises an arcuate exterior surface overlying thicker medial portions 1002 and 1005 and thinner lateral portions 1006 and 1007. The relationship of the thinner lateral portions 1006 and 1007 and the thicker medial portions 1002 and 1005 imparts a spring tension to the cable access slot cover 1001 that retains it in longitudinal cable access slot 308 and allows cable access slot cover 1001 to snap into place within longitudinal cable access slot 308.

At the opposite ends of the arcuate exterior surface, curved portions 1003 and 1004 are formed to engage the edges of support tube 301 within the longitudinal cable access slot 308. Curved portion 1003 comprises a proximate portion 1008 and a distal portion 1010. Curved portion 1004 comprises a proximate portion 1009 and a distal portion 1011. Since the arcuate exterior surface circumferentially spans the longitudinal cable access slot 308 and the proximate portions 1008 and 1009, respectively, of curved portions 1003 and 1004 are oriented radially with respect to an axis of support tube 301, the proximate portions 1008 and 1009 of curved portions 1003 and 1004, respectively, meet the arcuate exterior surface of the cable access slot cover 1001 at an angle of approximately ninety degrees. For example, the angle at which the proximate portion 1008 and/or the proximate portion 1009 meet the arcuate exterior surface may be between eighty and one hundred degrees. As another example, the angle may be between seventy and one hundred ten degrees.

The distal ends 1010 and 1011 of curved portions 1003 and 1004, respectively, angle away from each other so as to extend behind a portion of an interior surface of support tube 301, which allows cable access slot cover 1001 to snap into position within longitudinal cable access slot 308 and prevents cable access slot cover 1001 from falling out of longitudinal cable access slot 308.

In accordance with at least one embodiment, an overhead equipment mount comprises a support tube defining a longitudinal cable access slot and a plurality of support tube perforations, wherein the plurality of support tube perforations are defined along a support tube longitudinal line spanning a first portion of a support tube length of the support tube. In accordance with at least one embodiment, the overhead equipment mount further comprises a flange comprising a collar defining a plurality of first collar perforations, wherein the plurality of first collar perforations are defined along a collar longitudinal line spanning a first portion of a collar length of the collar, at least one of the plurality of first collar perforations adapted to align with at least one of the plurality of support tube perforations, one of the plurality of first collar perforations further adapted to receive a fastener, one of the plurality of support tube perforations adapted for engagement of the fastener, the collar further defining a second collar perforation angularly offset from the collar longitudinal line and a third collar perforation angularly offset from the collar longitudinal line and from the second collar perforation, the second and third collar perforations adapted to receive, respectively, a second fastener and a third fastener, the support tube adapted to engage the second and third fasteners.

In accordance with at least one embodiment, the flange further comprises a plate perpendicularly coupled to the collar, wherein the plate defines a plurality of plate perforations adaptable to attach the plate to a base. In accordance with at least one embodiment, the plurality of support tube perforations are threaded, the first plurality of collar perforations are unthreaded, and the second and third collar perforations are threaded. In accordance with at least one embodiment, a collar perforation spacing of the plurality of first collar perforations from each other along the collar longitudinal line bears an integer multiple relationship to a support tube perforation spacing of the plurality of support tube perforations from each other along the support tube longitudinal line. In accordance with at least one embodiment, the collar perforation spacing is between 0.25 inches and 0.75 inches and the support tube perforation spacing is between 2 inches and 3 inches. In accordance with at least one embodiment, the collar perforation spacing is between 0.45 inches and 0.55 inches and the support tube perforation spacing is between 1.9 inches and 2.1 inches. In accordance with at least one embodiment, the support tube perforation spacing is five times as far apart as the collar perforation spacing. In accordance with at least one embodiment, the first support tube perforation spacing is n times as far apart as the first collar perforation spacing, where n equals a number of the plurality of first collar perforations. As these examples illustrate, in accordance with at least one embodiment, the support tube perforation spacing on the support tube can be nominally two inches.

In accordance with at least one embodiment, the support tube has a generally C-shaped cross section. In accordance with at least one embodiment, the overhead equipment mount further comprises a cable access slot cover adaptable to cover at least a portion of the longitudinal cable access slot. In accordance with at least one embodiment, the support tube is threaded around its outside diameter at an end of the support tube.

In accordance with at least one embodiment, a method for providing an overhead equipment mount comprises perforating a support tube, along a support tube longitudinal line spanning a first portion of a support tube length of the support tube, to define a plurality of support tube perforations, wherein the support tube defines a longitudinal cable access slot. The method further comprises joining a plate to a collar to form a flange. The method further comprises perforating the collar to define a plurality of first collar perforations, wherein the plurality of first collar perforations are defined along a collar longitudinal line spanning a first portion of a collar length of the collar, at least one of the plurality of first collar perforations adapted to align with at least one of the plurality of support tube perforations, one of the plurality of first collar perforations further adapted to receive a fastener, one of the plurality of support tube perforations adapted for engagement of the fastener. The method further comprises perforating the collar to define a second collar perforation angularly offset from the collar longitudinal line and a third collar perforation angularly offset from the collar longitudinal line and from the second collar perforation, the second and third collar perforations adapted to receive, respectively, a second fastener and a third fastener, the support tube adapted to engage the second and third fasteners.

In accordance with at least one embodiment, the method further comprises tapping threads in the plurality of support tube perforations, the second collar perforation, and the third collar perforation. In accordance with at least one embodiment, the perforating the support tube comprises perforating the support tube such that the plurality of support tube perforations are spaced a support tube perforation spacing from each other, wherein perforating the collar to define a plurality of first collar perforations comprises perforating the collar to define the plurality of the first collar perforations such that the plurality of first collar perforations are spaced a collar perforation spacing from each other, wherein the support tube perforation spacing is an integer multiple of the collar perforation spacing. In accordance with at least one embodiment, the perforating the support tube such that the plurality of support tube perforations are spaced the support tube perforation spacing from each other further comprises perforating the support tube such that the support tube perforation spacing is n times the collar perforation spacing, where n is a number of the plurality of first collar perforations.

In accordance with at least one embodiment, the method further comprises threading an end of the support tube, wherein the support tube is adapted to engage threads of a bracket to coupled the support tube to equipment to be mounted. In accordance with at least one embodiment, the method further comprises extruding a cable access slot cover adaptable to cover at least a portion of the longitudinal cable access slot. In accordance with at least one embodiment, the method further comprises forming the support tube to define the longitudinal cable access slot by extruding the support tube. In accordance with at least one embodiment, the method further comprises forming the support tube to define the longitudinal cable access slot by rolling the support tube. In accordance with at least one embodiment, the method further comprises forming the support tube to define the longitudinal cable access slot by machining the support tube.

Thus, a method and apparatus for overhead equipment mounting is described. Although the present invention has been described with respect to certain specific embodiments, it will be clear to those skilled in the art that the inventive features of the present invention are applicable to other embodiments as well, all of which are intended to fall within the scope of the present invention.

What is claimed is:

1. An overhead equipment mount comprising:
a support tube defining a longitudinal cable access slot and a plurality of support tube perforations, wherein the plurality of support tube perforations are defined along a support tube longitudinal line spanning a first portion of a support tube length of the support tube; and
a flange comprising a collar defining a plurality of first collar perforations, wherein the plurality of first collar perforations are defined along a collar longitudinal line spanning a first portion of a collar length of the collar, at least one of the plurality of first collar perforations adapted to align with at least one of the plurality of support tube perforations, one of the plurality of first collar perforations further adapted to receive a fastener, one of the plurality of support tube perforations adapted for engagement of the fastener, the collar further defining a second collar perforation angularly offset from the collar longitudinal line and a third collar perforation angularly offset from the collar longitudinal line and from the second collar perforation, the second and third collar perforations adapted to receive, respectively, a second fastener and a third fastener, the support tube adapted to engage the second and third fasteners.

2. The overhead equipment mount of claim 1 wherein the flange further comprises:
a plate perpendicularly coupled to the collar, wherein the plate defines a plurality of plate perforations adaptable to attach the plate to a base.

3. The overhead equipment mount of claim 1 wherein the plurality of support tube perforations are threaded, the first plurality of collar perforations are unthreaded, and the second and third collar perforations are threaded.

4. The overhead equipment mount of claim 1 wherein a collar perforation spacing of the plurality of first collar perforations from each other along the collar longitudinal line bears an integer multiple relationship to a support tube perforation spacing of the plurality of support tube perforations from each other along the support tube longitudinal line.

5. The overhead equipment mount of claim 4 wherein the collar perforation spacing is between 0.25 inches and 0.75 inches and the support tube perforation spacing is between 1.5 inches and 2.5 inches.

6. The overhead equipment mount of claim 5 wherein the collar perforation spacing is between 0.45 inches and 0.55 inches and the support tube perforation spacing is between 1.9 inches and 2.1 inches.

7. The overhead equipment mount of claim 4 wherein the support tube perforation spacing is five times as far apart as the collar perforation spacing.

8. The overhead equipment mount of claim 4 wherein the first support tube perforation spacing is n times as far apart as the first collar perforation spacing, where n equals a number of the plurality of first collar perforations.

9. The overhead equipment mount of claim 1 wherein the support tube has a C-shaped cross section.

10. The overhead equipment mount of claim 9 further comprising:
a cable access slot cover adaptable to cover at least a portion of the longitudinal cable access slot.

11. The overhead equipment mount of claim 10 wherein the support tube is threaded around its outside diameter at an end of the support tube.

12. A method for providing an overhead equipment mount comprising:
perforating a support tube, along a support tube longitudinal line spanning a first portion of a support tube length of the support tube, to define a plurality of support tube perforations, wherein the support tube defines a longitudinal cable access slot;
joining a plate to a collar to form a flange;
perforating the collar to define a plurality of first collar perforations, wherein the plurality of first collar perforations are defined along a collar longitudinal line spanning a first portion of a collar length of the collar, at least one of the plurality of first collar perforations adapted to align with at least one of the plurality of support tube perforations, one of the plurality of first collar perforations further adapted to receive a fastener, one of the plurality of support tube perforations adapted for engagement of the fastener; and
perforating the collar to define a second collar perforation angularly offset from the collar longitudinal line and a third collar perforation angularly offset from the collar longitudinal line and from the second collar perforation, the second and third collar perforations adapted to receive, respectively, a second fastener and a third fastener, the support tube adapted to engage the second and third fasteners.

13. The method of claim 12 further comprising:
tapping threads in the plurality of support tube perforations, the second collar perforation, and the third collar perforation.

14. The method of claim 12 wherein perforating the support tube comprises:
perforating the support tube such that the plurality of support tube perforations are spaced a support tube perforation spacing from each other, wherein perforating the collar to define a plurality of first collar perforations comprises perforating the collar to define the plurality of the first collar perforations such that the plurality of first collar perforations are spaced a collar perforation spacing from each other, wherein the support tube perforation spacing is an integer multiple of the collar perforation spacing.

15. The method of claim 14 wherein the perforating the support tube such that the plurality of support tube perforations are spaced the support tube perforation spacing from each other further comprises:
perforating the support tube such that the support tube perforation spacing is n times the collar perforation spacing, where n is a number of the plurality of first collar perforations.

16. The method of claim 12 further comprising:
threading an end of the support tube, wherein the support tube is adapted to engage threads of a bracket to coupled the support tube to equipment to be mounted.

17. The method of claim 16 further comprising:
extruding a cable access slot cover adaptable to cover at least a portion of the longitudinal cable access slot.

18. The method of claim 17 further comprising:
forming the support tube to define the longitudinal cable access slot by extruding the support tube.

19. The method of claim 17 further comprising:
forming the support tube to define the longitudinal cable access slot by rolling the support tube.

20. The method of claim 17 further comprising:
forming the support tube to define the longitudinal cable access slot by machining the support tube.
